(19) United States
(12) Patent Application Publication
(10) Pub. No.: US 2020/0233491 A1
(43) Pub. Date: Jul. 23, 2020

(54) METHOD AND SYSTEM FOR GENERATING A PROJECTION VIDEO

(71) Applicant: BROGENT TECHNOLOGIES INC., Kaohsiung (TW)

(72) Inventors: You-Cheng WANG, Kaohsiung (TW); Meng-Wen LI, Kaohsiung (TW)

(21) Appl. No.: 16/749,200

(22) Filed: Jan. 22, 2020

(30) Foreign Application Priority Data
Jan. 23, 2019 (TW) 108102472

(51) Int. Cl. G06F 3/01; G06T 19/00; H04N 9/31

(52) U.S. Cl. CPC G06F 3/013; H04N 9/3141; G06T 19/00

(57) ABSTRACT

A method for generating a projection video for a user on a carrier simulating movement of a vehicle and wearing a display device is provided. The method includes steps of: while the carrier is in motion, continuously determining an estimated eyesight direction of the user and determining a current state of the carrier; obtaining to-be-presented image data in a specific environment based on the estimated eyesight direction and the current state of the carrier; based on the to-be-presented image data, generating the projection video that reflects a part of a simulated environment reflecting the specific environment; and presenting, using the display device, the projection video to the user.

### CROSS-REFERENCE TO RELATED APPLICATION

This application claims priority of Taiwanese Patent Application No. 108102472, filed on Jan. 23, 2019.

### FIELD

The disclosure relates to a method and a system for generating a projection video, more particularly to a method and a system for generating a projection video for a user on a carrier simulating a moving vehicle.

### BACKGROUND

Currently, motion simulators have been utilized in various applications such as amusement rides (e.g., a dark ride). In use, a motion simulator may cooperate with a visual display that projects or shows a visual scene of the outside world (OTW) (e.g., a video of a real location recorded by a drone), and, in other occasions, may generate a projection video which shows a three dimensional (3D) simulated environment (e.g., of a video game) that can be projected by the visual display. The visual scene and the 3D simulated environment aim to give an occupant or a user of the motion simulator the feeling that he/she is actually in the outside world and in the 3D simulated environment, respectively.

One key issue related to the 3D simulated environment is preventing the user from feeling dizzy after a relatively long period of use. Dizziness may originate from a discrepancy between a view anticipated by the user's brain (expected view) and a view actually provided by the projection video, especially in the case when the user is wearing a virtual reality (VR) headset and is seated on a carrier (e.g., provided by the amusement rides).

The projection video may be pre-created using a conventional method (e.g., recorded using a camera) and presented to the user. In one example of FIG. 1, the ride may be a simulation of driving a vehicle 10 on a road. When the vehicle 10 travels in a direction (D1) uphill at an inclination angle θ, the projection video may generally have an angle of view in agreement with the direction (D1).

However, in cases that the user does not move his/her head in agreement with the direction (D1) (e.g., only tilts slightly up, at an angle much less than the inclination angle θ), the eyesight of the user (D2) would not match the direction (D1), and the expected view and the projection video presented to the user would be different. This discrepancy may be one cause of dizziness while the user experiences the virtual reality in the 3D simulated environment.

### SUMMARY

One object of the disclosure is to provide a method for generating a projection video for a user on a carrier simulating movement of a vehicle.

According to one embodiment of the disclosure, the method is implemented by a system including a computer device and a display device. The method includes steps of:

while the carrier is in motion, by the computer device, continuously determining an estimated eyesight direction of the user and determining a current state of the carrier;

by the computer device, obtaining to-be-presented image data in a specific environment according to the estimated eyesight direction and the current state of the carrier;

by the computer device, transmitting the to-be-presented image data to the display device; and

by the display device, generating and presenting a series of images to the user based on the to-be-presented image data, the series of image composing a projection video that constitutes a part of a simulated environment reflecting the specific environment.

Another object of the disclosure is to provide a system that is capable of implementing the above-identified method.

According to one embodiment of the disclosure, the system includes system for generating a projection video for a user on a carrier simulating movement of a vehicle, the system comprising a computer device and a display device that is to be worn by a user, the computer device communicating with the display device and including a processor that is configured to:

while the carrier is in motion, continuously determine an estimated eyesight direction of the user and determining a current state of the carrier;

obtain to-be-presented image data in a specific environment according to the estimated eyesight direction and the current state of the carrier; and

transmit the to-be-presented image data to the display device.

The display device is configured to generate and present a series of images to the user based on the to-be-presented image data. The series of image composes a projection video that constitutes a part of a simulated environment reflecting the specific environment.

### BRIEF DESCRIPTION OF THE DRAWINGS

Other features and advantages of the disclosure will become apparent in the following detailed description of the embodiments with reference to the accompanying drawings, of which:

FIG. 1 illustrates a potential difference between a direction of perspective of a projection video and a direction of perspective of a user in a carrier;

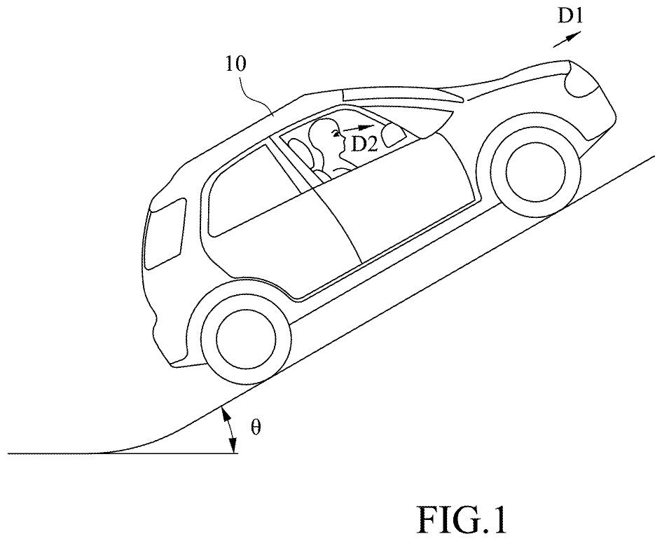

FIG. 2 is a block diagram illustrating a system for generating a projection video that simulates a specific environment according to one embodiment of the disclosure;

FIG. 3 is a flow chart illustrating steps of a method for generating a projection video that simulates a specific environment according to one embodiment of the disclosure;

FIG. 4 illustrates a user on a carrier and an exemplary projection video according to one embodiment of the disclosure;

FIG. 5 illustrates a potential difference between a moving direction of a vehicle and a direction of perspective of a driver;

FIG. 6 illustrates a user on an alternative carrier and an exemplary projection video according to one embodiment of the disclosure; and

FIG. 7 illustrates a potential difference between a tilt angle of a motorcycle that is in a lean position and a tilt angle of a head of a rider of the motorcycle.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

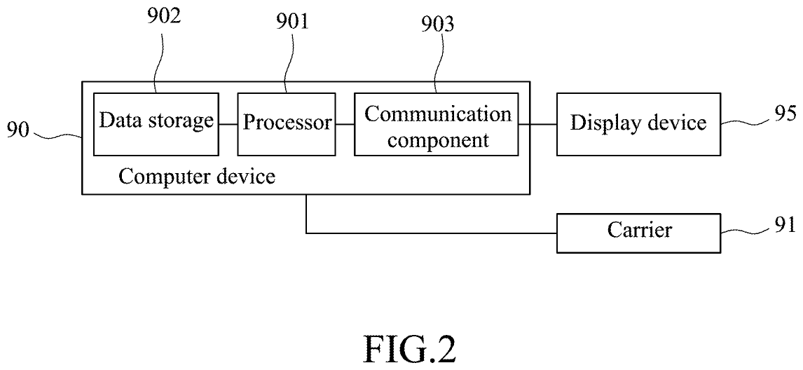

FIG. 2 is a block diagram illustrating a system for generating a projection video for an occupant (user) of a carrier that simulates movement of a vehicle according to one embodiment of the disclosure. The system includes a computer device 90, a carrier 91 and a display device 95.

The computer device 90 includes a processor 901, a data storage 902 and a communication component 903.

The processor 901 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

The data storage 902 may be embodied using a physical storage module such as a hard disk drive, a solid-state drive, a random access memory (RAM), flash memory, etc., and stores a software application and a pre-constructed environment model therein. The software application includes instructions that, when executed by the processor 901, cause the processor 901 to execute a number of operations as described below.

The environment model may be created using a virtual reality (VR) world building technique known in the art (e.g., UNITY®, UNREAL ENGINE®, etc.), and includes environment data constituting a specific environment (such as a real-world visual scene of the outside world (OTW), a simulated location, etc.). Specifically, the environment data enables the specific environment to be presented to the user using a display (e.g., the display device 95).

The communication component 903 may include a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) and/or fourth generation (4G) of wireless mobile telecommunications technology, and/or the like. In this embodiment, the communication component 903 is for connection with the carrier 91 and the display device 95.

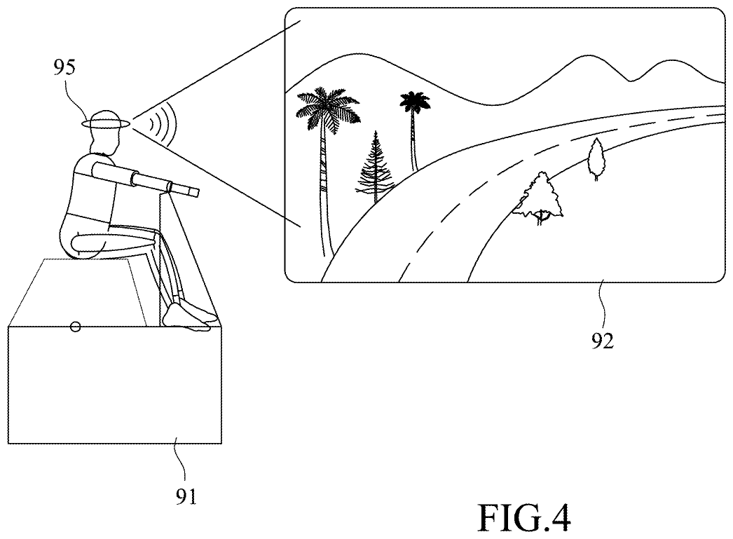

In this embodiment, the carrier 91 is a platform on which one or more users may sit, and is controlled (by, for example, the computer device 90) to simulate movement of a vehicle. For example, the vehicle is a autonomous vehicle as seen in FIG. 4. In this embodiment, the carrier 91 may be disposed on a motion simulator such as a ride simulator.

The display device 95 may be embodied using a wearable device such as a head-mounted display, and communicates with the computer device 90. In this embodiment, the display device 95 is embodied using a VR headset that is worn by the user. The VR headset includes a display screen, an orientation detector (such as a gyroscope, a gyrocompass, a magnetometer, etc.), and a communication component for communicating with the computer device 90. When the VR headset is activated, the orientation detector generates orientation data indicating the direction of head turn (and thus eyesight) of the user. As the user moves his/her head, the movement of the head-mounted display corresponding to the movement of the user's head may be detected.

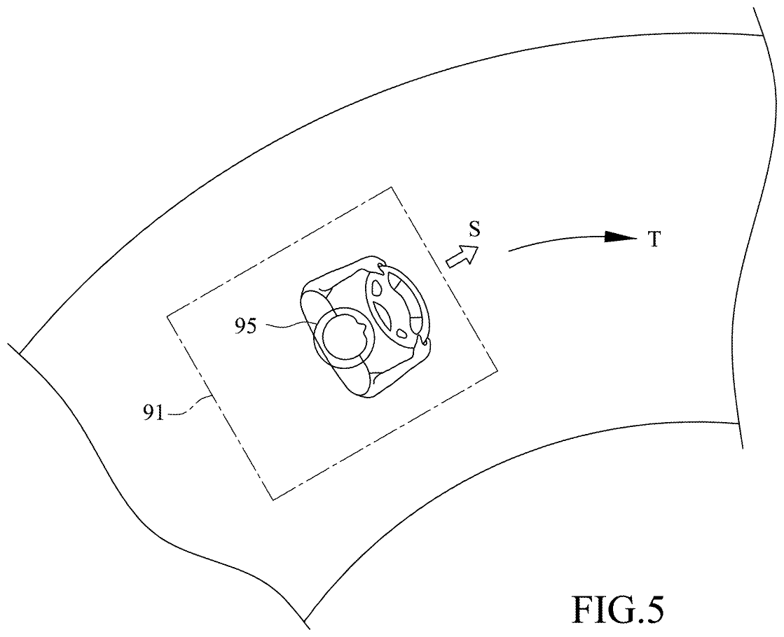

As seen in FIGS. 4 and 5, when the user wears the display device 95 and sits on the carrier 91, a simulated ride may commence. During the simulated ride, the carrier 91 may be controlled to move in a predetermined fashion, and the display device 95 is controlled (by, for example, the computer device 90) to present a projection video 92 that, along with the movements of the carrier 91, constitute a three dimensional (3D) simulated environment to the user.

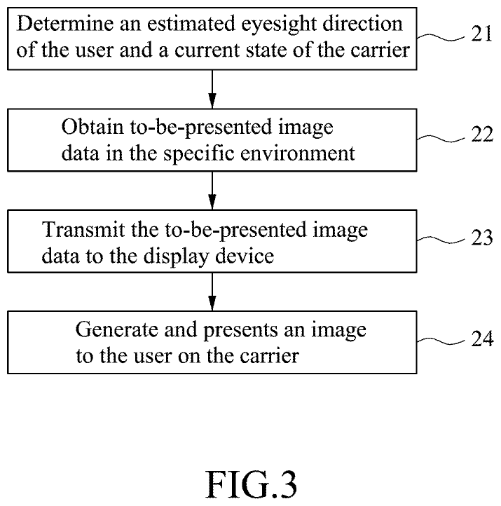

FIG. 3 is a flow chart illustrating steps 21-24 of a method for generating a projection video that simulates the specific environment during the simulated ride, according to one embodiment of the disclosure.

In this embodiment, the method is implemented using the system as shown in FIG. 2, with a user wearing the display device 95 and sitting on the carrier 91.

In step 21, while the carrier 91 is in motion, the processor 901 continuously determines an estimated eyesight direction of the user and a current state of the carrier 91.

Specifically, in one example, the 3D simulated environment is presented as a sports car moving on a highway for the simulated ride. As such, the carrier 91 is controlled to simulate movement along a route on the highway based on one of a plurality of scripts stored in the data storage 902. Each script may include an ordered list of movements and a number of time instances corresponding to the movements.

In order to generate a projection video 92 that accurately reflects a view from the perspective of a driver of the sports car (i.e., the user sitting on the carrier 91), the processor 901 may be configured to obtain a number of specific parameters during the simulated ride.

In this embodiment, the specific parameters include the estimated eyesight direction of the user, a location of the carrier 91 as projected in the specific environment, and an orientation of the carrier 91 as projected in the specific environment. The location and the orientation of the carrier 91 serve as the current state of the carrier 91.

In one example as shown in FIG. 4, the carrier 91 is simulating movement of a autonomous vehicle on a curved road. As shown in FIG. 5, the carrier 91 is simulating the autonomous vehicle turning right, which is a movement represented by an arrow (T). It is noted that the estimated eyesight direction of the user (as represented by an arrow (S)) may not conform with a direction of the simulated movement. As such, the estimated eyesight direction (S) of the user, instead of the direction of the simulated movement of the vehicle, may be taken into consideration in generating the projection video 92.

In this embodiment, the estimated eyesight direction (S) of the user may be obtained by obtaining the orientation data from the orientation detector of the display device 95 worn by the user, and calculating the estimated eyesight direction based on the orientation data (e.g., the orientation data may be converted into the form of a set of spherical coordinate system indicating the estimated eyesight direction). The location and the orientation of the carrier 91 within the specific environment at a specific time during the simulated ride may be obtained based on the scripts.

In step 22, the processor 901 obtains to-be-presented image data in the specific environment according to the estimated eyesight direction (S) of the user and the current state of the carrier 91.

Specifically, in this step, the processor 901 accesses the environment model stored in the data storage 902 to obtain a part of the environment data that corresponds with the estimated eyesight direction (S) and the location and the orientation of the carrier 91 in the specific environment, and uses the part of the environment data as the to-be-presented image data.

Specifically, the location of the carrier 91 in the specific environment may be obtained by obtaining a current time instance, and determining the location of the carrier 91 with reference to the one of the plurality of scripts stored in the data storage 902 used for the simulated ride based on the current time instance (e.g., by referring to one of the movements listed in the script that corresponds to the current time instance, and a corresponding displacement of the carrier 91 within the specific environment based on the movements made). The orientation of the carrier 91 may be obtained by the processor 901 establishing a communication with the carrier 91, and obtaining the orientation of the carrier 91 from an orientation detector (not depicted in the drawings) mounted on the carrier 91.

In step 23, the processor 901 transmits the to-be-presented image data to the display device 95 through the communication component 903.

In step 24, the display device 95 generates and presents an image to the user on the carrier 91 based on the to-be-presented image data.

It is noted that during the simulated ride, steps 21 to 24 are continuously performed. That is to say, as the simulated ride progresses, the estimated eyesight direction and the location and the orientation of the carrier 91 may change rapidly, and as a result, different to-be-presented image data is continuously obtained and transmitted to the display device 95 in step 24, and thus a series of images are presented to the user on the carrier 91 sequentially, giving the user the feeling of watching a video. That is to say, the series of images compose the projection video 92 that constitutes a part of the 3D simulated environment reflecting the specific environment.

In use, when a user is on the carrier 91 to experience the simulated ride, the carrier 91 may be controlled to have a number of carrier movements that simulate movements experienced by a vehicle when traveling along a preset route, and make a number of specific movements within the preset route. For each of the specific movements, the projection video 92 presented to the user is generated based on the estimated eyesight direction of the user and the location and the orientation of the carrier 91, and therefore may more accurately reflect a movement of the head of the user. Therefore, a situation that the user may feel dizzy when experiencing the simulated ride may be alleviated or eliminated.

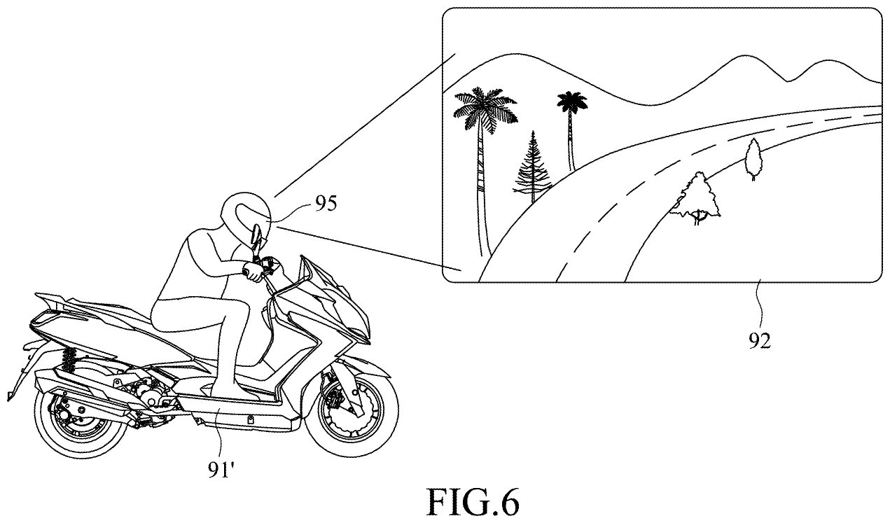

FIG. 6 illustrates an alternative carrier 91′ according to one embodiment of the disclosure. Specifically, the carrier 91′ is in the form of a motorcycle.

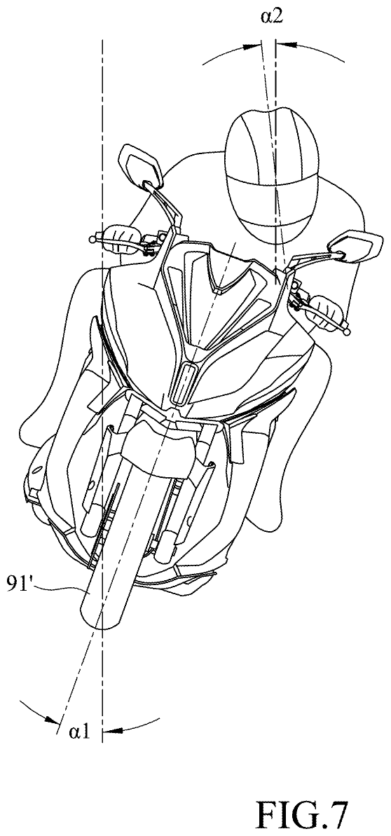

It is noted that when a motorcycle is making a turn, in order to maintain balance, a rider of the motorcycle may need to lean to one side by a lean angle. In one example shown in FIG. 7, the carrier 91′ may be leaned by a lean angle of α1, and the rider may tilt his/her head in response to the leaning of the motorcycle by a tilt angle α2.

In such a case, the tilt angle α2 associated with the head of the rider may be different from the lean angle α1 (e.g., the tilt angle α2 may be smaller than the lean angle α1, meaning that the head of the rider is not as tilted as the motorcycle). Accordingly, the orientation data generated by the orientation detector of the display device 95 worn by the user further includes the tilt angle α2.

In such a case, the above-mentioned method may be performed for the carrier 91′ so that, when a user is on the carrier 91′ to experience the simulated ride, the carrier 91′ may be controlled to move along a preset route, and make a number of specific movements within the preset route, including leaning. For each of the specific movements, the projection video 92 presented to the user is generated based on the estimated eyesight direction of the user on the carrier 91′, a location and an orientation of the carrier 91′. In this way, a situation that the user may feel dizzy when experiencing the simulated ride may be alleviated or eliminated.

To sum up, embodiments of the disclosure provide a method and a system for generating a projection video 92 for a user on a carrier. Specifically, when generating the projection video while the carrier is moving, the system is configured to generate the projection video 92 based on to-be-presented image data that is obtained from the environment model based on the estimated eyesight direction and the location and the orientation of the carrier in a specific environment created by the projection video 92.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for generating a projection video for a user on a carrier simulating movement of a vehicle, the method to be implemented by a system including a computer device and a display device, the method comprising steps of:
while the carrier is in motion, by the computer device, continuously determining an estimated eyesight direction of the user and determining a current state of the carrier;
by the computer device, obtaining to-be-presented image data in a specific environment according to the estimated eyesight direction and the current state of the carrier;
by the computer device, transmitting the to-be-presented image data to the display device; and
by the display device, generating and presenting a series of images to the user based on the to-be-presented image data, the series of image composing a projection video that constitutes a part of a simulated environment reflecting the specific environment.

2. The method of claim 1, the display device including an orientation detector, wherein the step of determining the estimated eyesight direction of the user includes:
obtaining orientation data from the orientation detector of the display device worn by the user; and
calculating the estimated eyesight direction based on the orientation data.

3. The method of claim 2, wherein the step of determining the current state of the carrier includes determining a location and an orientation of the carrier as projected in the specific environment.

4. The method of claim 3, the display device further including a processor and a data storage that stores therein an environment model that includes environment data constituting the specific environment, wherein:
the step of obtaining to-be-presented image data includes the processor accessing the environment model to obtain apart of the environment data that corresponds with the estimated eyesight direction and the location and the orientation of the carrier as projected in the specific environment, and using the part of the environment data as the to-be-presented image data.

5. The method of claim 3, the display device being in communication with a computer device, the computer device including processor and a data storage that stores therein a software program and an environment model constituting the specific environment, wherein:
the step of obtaining to-be-presented image data includes the processor accessing the environment model to obtain a part of the environment data that corresponds with the estimated eyesight direction and the location and the orientation of the carrier, and using the part of the environment data as the to-be-presented image data.

6. A system for generating a projection video for a user on a carrier simulating movement of a vehicle, the system comprising a computer device and a display device that is to be worn by a user, said computer device communicating with said display device and including a processor that is configured to:
while the carrier is in motion, continuously determine an estimated eyesight direction of the user and determining a current state of the carrier;
obtain to-be-presented image data in a specific environment according to the estimated eyesight direction and the current state of the carrier; and
transmit the to-be-presented image data to said display device;
wherein said display device is configured to generate and present a series of images to the user based on the to-be-presented image data, the series of image composing a projection video that constitutes a part of a simulated environment reflecting the specific environment.

7. The system of claim 6, wherein said display device includes an orientation detector, and said processor of said computer device is configured to determine the estimated eyesight direction of the user by:
obtaining orientation data from said orientation detector of said display device worn by the user; and
calculating the estimated eyesight direction based on the orientation data.

8. The system of claim 7, wherein said processor of said computer device is configured to determine the current state of the carrier by determining a location and an orientation of the carrier as projected in the specific environment.

9. The system of claim 6, wherein said computer device further includes a data storage that stores therein a software program and an environment model constituting the specific environment, and wherein said processor is configured to obtain the to-be-presented image data by accessing the environment model to obtain a part of the environment data that corresponds with the estimated eyesight direction and the location and the orientation of the carrier as projected in the specific environment, and to use the part of the environment data as the to-be-presented image data.
